(19) United States
(12) Patent Application Publication
(10) Pub. No.: US 2005/0025420 A1
(43) Pub. Date: Feb. 3, 2005

(54) Optical sub-assembly laser mount having integrated microlens

(76) Inventor: Mina Farr, Palo Alto, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/879,239

(22) Filed: Jun. 29, 2004

Related U.S. Application Data
(60) Provisional application No. 60/483,740, filed on Jun. 30, 2003.

(51) Int. Cl. G02B 6/32

(52) U.S. Cl. 385/33

(57) ABSTRACT

Optical micro-modules include a laser mount having an integrated light emitter, an integrated lens holder, and an integrated microlens. The microlens, which preferably collimates light received from the light emitter, is attached to a front surface of the lens holder and aligned with the light emitter. The light emitter and the lens holder are affixed side by side on a substrate in the micro module so that the microlens can be aligned with the light emitter during fabrication of the micro-module at the wafer level rather than during later assembly. A ball lens may optionally be used to focus the light exiting the microlens into an optical fiber. An optical isolator, a thermoelectric cooler, and/or a back monitor, such as a wavelength locker, are also preferably incorporated.

### CROSS-REFERENCE TO RELATED APPLICATIONS

This application claims the benefit of U.S. Provisional Application No. 60/483,740, filed Jun. 30, 2003, which is hereby incorporated herein by reference.

### BACKGROUND OF THE INVENTION

1. The Field of the Invention

The present invention relates generally to high speed data transmission systems. More particularly, embodiments of the invention relate to optical micro-modules for use in optical transmitters.

2. The Relevant Technology

The use of fiber optic technology is an increasingly important method of data transmission. Through fiber optics, digital data in the form of light signals is formed by light emitting diodes or lasers and then propagated through a fiber optic cable. Such light signals allow for high data transmission rates and high bandwidth capabilities. Other advantages of using light signals for data transmission include their resistance to electromagnetic radiation that interferes with electrical signals; fiber optic cables' ability to prevent light signals from escaping, as can occur electrical signals in wire-based systems; and light signals' ability to be transmitted over great distances without the signal loss typically associated with electrical signals on copper wire. However, it is often necessary to connect an electrical signal to a light signal and vice versa.

One conventional device used to translate electrical signals into light signals is a transmitter optical subassembly (TOSA). TOSAs typically include an electrical interface for receiving electrical signals; a data encoder/modulator for modulating the electrical signals, and a light emitting diode or laser to form the modulated light signal. After the light signal leaves the light emitting diode or laser it typically passes through one or more isolators and lenses used to couple the light signal with an optical waveguide, such as a fiber optic cable. Each of the light emitter, isolator(s), and lens(es) are typically structurally distinct and isolated within a TOSA housing.

Because of the small size of the various components in a TOSA and the importance of precisely aligning the components, in particular the lens(es), TOSAs can be relatively difficult and expensive to manufacture. For example, one important component in conventional TOSAs is the coupling lens, which is a small, commonly aspherical, glass lens that focuses the light received from the laser into the optical fiber. The coupling lens must be of high optical quality and be carefully aligned at the proper focal length from the light source and from the optical fiber during the manufacture of the TOSA in order to achieve high coupling efficiency of the laser into the optical fiber. As a result, both because of their individual cost and the added cost in manufacturing TOSAs, the use of aspheric glass lenses adds a considerable cost to TOSAs.

Accordingly, there is a continuing need for more easily assembled, less expensive optical components and devices for use in TOSAs and other optical devices that create and propagate optical signals with high efficiency.

### SUMMARY OF EMBODIMENTS OF THE INVENTION

In general, embodiments of the invention are concerned with micro-modules for use in transmitter optical devices and methods of manufacturing the micro-modules. More particularly, the herein disclosed micro-modules use a lens holder in an optical micro-module laser mount having an integrated microlens. The micro-modules can be manufactured at the wafer scale level with numerous pairs of light emitters and back monitors positioned on a substrate, such as a silicon wafer. Through a series of additional processing steps described below a number of optical micro-module laser mounts having integrated microlenses can be quickly and efficiently manufactured for ease of assembly into a complete TOSA.

Embodiments of the present invention allow wafer scale alignment of lenses to light emitters rather than the conventional device level alignment, thus improving the process of TOSA assembly and lowering manufacturing costs. Other presently recognized advantages of embodiments of the invention include: the relatively low cost of using a mass produced aspheric silicon microlens; the excellent tolerances (microlens to laser and micro-module to secondary lens); an improved thermal performance; the applicability of embodiments of the present invention to a variety of platforms, including for example, cooled, uncooled, EML, butterfly, and the like; improved isolator or quarter waveplate performance and cost due to the small diameter collimated beam effects of the microlens; and the application of the present invention to passive collimated geometries.

According to one embodiment of the invention, an optical micro-module includes a light emitter mounted upon a substrate, a lens holder mounted upon the substrate adjacent the light emitter, the lens holder having a mounting surface, and a lens attached to the mounting surface of the lens holder and having a lens optical axis that is aligned with the light emitter.

According to another embodiment of the invention an optical micro-module includes a laser diode mounted or formed upon a substrate. A lens holder having a lens mounting surface is also mounted upon the substrate adjacent the light emitter. A microlens is attached to the mounting surface of the lens holder and has a lens optical axis that is aligned with the light emitter at a desired focal length. The microlens collimates or focuses the light received from the laser diode or other light source. The optical micro module also includes a back monitor affixed to the submount and configured to receive a portion of the light emitted by the laser diode. A ball lens receives the collimated or focused beam of light from the microlens and couples the light into an optical fiber.

According to yet another embodiment of the invention, a method of assembling an optical micro-module includes first forming or affixing a plurality of light emitters, and optionally back monitors, to a submount in a grid pattern. The submount is cut or otherwise separated into micro-module rows with the light emitters arranged in a linear row on each micro-module row. A plurality of lens holders is then affixed to the submount adjacent to the light emitters. Before being affixed to the submount, the lens holders are selectively aligned in the z-axis direction (along the laser channel) relative to the light emitter. The micro-module may be placed in a vertical holding assembly for convenience in preparation for receiving at least the microlenses. The microlenses are then attached to corresponding lens holders and each microlens is pre-aligned in the z-axis by the position of the lens holder. Each microlens is aligned in the x-axis and y-axis relative to the light emitter before being attached to the lens holder. Finally, the micro-module rows are optionally scribed for breaking into individual sub-modules and are then broken or cut into the individual sub-modules.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a schematic diagram that illustrates aspects of an optical micro-module according to embodiments of the invention;

FIG. 1B is another schematic diagram that illustrates aspects of an optical micro-module according to embodiments of the invention;

FIG. 2 is yet another schematic diagram that illustrates aspects of an optical micro-module according to embodiments of the invention;

FIG. 3 is a further schematic diagram that illustrates aspects of a wavelength locker for use with optical micro-modules according to embodiments of the invention;

FIG. 4 is another schematic diagram that illustrates aspects of a wavelength locker for use with optical micro-modules according to embodiments of the invention;

FIG. 5A is a schematic diagram that illustrates aspects of a method of assembling an optical micro-module according to embodiments of the invention;

FIG. 5B is another schematic diagram that illustrates aspects of a method of assembling an optical micro-module according to embodiments of the invention;

FIG. 5C is another schematic diagram that illustrates aspects of a method of assembling an optical micro-module according to embodiments of the invention;

FIG. 5D is another schematic diagram that illustrates aspects of a method of assembling an optical micro-module according to embodiments of the invention; and

FIG. 5E is another schematic diagram that illustrates aspects of a method of assembling an optical micro-module according to embodiments of the invention.

### DETAILED DESCRIPTION OF THE INVENTION

In general, embodiments of the invention are concerned with micro-modules for use in transmitter optical sub-assemblies (TOSAs) having a laser axis along the TOSA axis and methods of manufacturing the micro-modules. More particularly, the herein disclosed micro-modules use a lens holder to create an optical micro-module laser mount having an integrated microlens. The micro-modules can be manufactured at the wafer scale level with numerous pairs of light emitters positioned on a submount, such as a silicon wafer. Through a series of additional processing steps described below, a number of optical micro-module laser mounts, each having an integrated microlens, can be quickly and efficiently manufactured for assembly into a complete TOSA.

Because conventional TOSAs do not include a lens holder that is attached to the light emitter's submount, conventional TOSAs require a complicated device level alignment to properly align the lens with the light emitter. In contrast, embodiments of the present invention allow wafer scale alignment rather than the conventional device level alignment, thus simplifying the process and lowering costs.

In another embodiment of the invention, a secondary lens (such as, for example, a ball lens) is used in addition to the integrated microlens. Coupling efficiency can thereby be improved because the small microlens with very high Numerical Aperture (NA) can be positioned closer to the light emitter than the conventional bulk lenses. Thus, a greater percentage of the light signal is received and collimated or focused by the microlens and directed onto the secondary lens, which then focuses the light signal into an optical fiber. If the secondary lens is omitted the microlens can focus the light directly into the receiving fiber.

Other presently recognized advantages of embodiments of the invention include: the relatively low cost of using a mass produced high quality aspheric silicon microlens; the precise tolerances achievable in the microlens to laser alignment and the relieved tolerances of aligning the micro-module to a secondary lens; an improved thermal performance; the applicability of embodiments of the present invention to a variety of TOSA platforms, including for example, cooled, uncooled, EML, butterfly, and the like; improved isolator or quarter waveplate performance due to the collimating effects of the microlens; and the application of the present invention to passives collimated geometry.

Reference will now be made to the drawings to describe various aspects of exemplary embodiments of the invention. It is to be understood that the drawings are diagrammatic and schematic representations of such exemplary embodiments, and are not limiting of the present invention, nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of optical systems have not been described in particular detail in order to avoid unnecessarily obscuring the present invention.

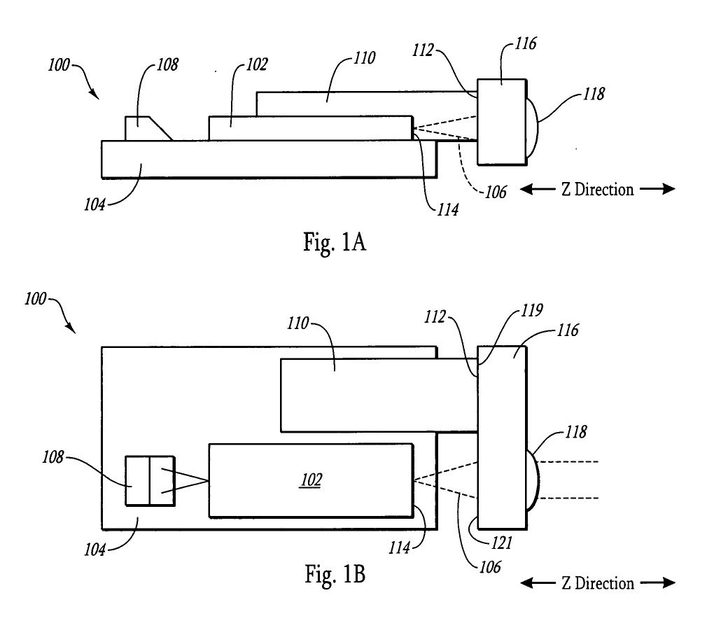

Reference is now made to FIGS. 1A and 1B, which present side and top block diagrams of an optical sub-assembly laser mount having an integrated microlens (microlens subassembly), designated generally at 100. The microlens assembly 100 includes a laser diode 102 mounted upon a silicon submount 104. The silicon submount 104 is referred to as such in that it is the predominantly used material for wafer level manufacturing commonly referred to as Silicon Micro Bench. Of course, one skilled in the art will recognize that various embodiments of the invention may have differing details, including different methods of production, and may therefore not necessarily require the submount to be silicon. Therefore, as used herein, the terms “substrate” and “submount” refer to one or more layers or structures, either monolithic or including active or operable portions of electronic or optical devices. For simplicity in describing the present invention and to avoid obscuring other aspects of the invention, however, the submounts and substrates of the present invention corresponding in function to silicon submount 104 will be collectively referred to as the silicon submount.

Although laser diode 102 is preferably an electroabsorptive modulated laser (EML), a DBF laser, a FP laser or the like, it will be appreciated that any edge emitting light signal source with any substrate thickness and geometry may be compatible with embodiments of the invention. Light emitters convert an electrical signal into a corresponding light signal that can be coupled into a fiber. The light emitter is an important element because it is often the most costly element in the system and its characteristics often strongly influence the final performance limits of a given link. Among the key characteristics of light emitters is their numerical aperture and the resulting emission pattern, which is the pattern of emitted light, depicted in FIGS. 1A and 1B at 106. The emission pattern affects the amount of light that can be coupled into the optical fiber because a broad emission pattern means that the coupling lens system needs to have high enough magnification to convert the high NA of the laser to match the NA of the optical fiber, or otherwise a large amount of the emitted light does not enter the optical fiber. The percentage of emitted light that enters an optical fiber is referred to as the coupling efficiency. Thus, ideally the size of the emitting region should be minimal to maximize the coupling efficiency with a reasonable size optics, at reasonable size distance from the light source, with reasonable aberration correction for the effective NA of the lens used.

Also mounted upon submount 104 is an optional back monitor 108, which may be, for example, a rear facet monitor photodiode or a wavelength locker, which monitors the intensity of light emitted by laser diode 102 as well as the signal wavelength. The monitored light signal is received from a back facet of laser diode 102 or from a siphoned portion of the laser light. While monitoring the light signal emitted by laser diode 102, back monitor 108 provides feedback to laser diode 102 or other devices in the TOSA to adjust the optical signal as needed. Greater details regarding back monitors are provided below in the discussion related to wavelength lockers.

Also mounted upon submount 104 is lens holder 110. Lens holder 110 is attached to submount 104, for example by a solder, and provides the proper focal distance between laser diode 102 and microlens 116 through its z-axis positioning. This is accomplished by precisely aligning lens holder 110 so that the lens holder has a mounting surface 112 at a selected distance from the light emitting surface 114 of laser diode 102. Thus, the z-axis alignment of microlens 116 is provided during assembly of the microlens subassembly 100 and thereby eliminates any later z-axis alignment for microlens 116. Because the curvature of each microlens could vary due to lens process variations, the z-axis alignment of each lens holder is customized for the curvature variance in individual lenses. The curvature of each microlens is therefore measured before the assembly of the microlens subassemblies, most commonly as a Quality Assurance parameter during the wafer level lens manufacturing process.

One embodiment of microlens 116 is formed as part of an aspheric microlens array by fabrication techniques that are known in the art. In a reflow process, for example, polymeric materials are patterned on substrates and then melted on the polymer to form ideal spherical surfaces. These patterns are then transferred into the substrate by various plasma etching techniques, where the precise control of the etching process, accommodates the required asphericity of the lens surface. One such microlens fabrication technique involves forming squat cylinders of photoresist on a silicon substrate using conventional lithography. The substrate is then heated above the glass reflow temperature of the photoresist, allowing it to reflow. This creates a series of spherical surfaces, each with a radius that may be predicted from the volume of resist and the area of contact with the substrate

The precise aspheric lens profiles are then transferred into the substrate material, often with 1:1 selectivity plus additional aspheric quality required (depending on the optical system design). This is performed as a high frequency, high power signal is inductively coupled into a vacuum chamber containing reactive gases at low pressure to form a high-density plasma. The substrate to be etched is mounted on a driven stage remotely from the plasma generation region. The bias on the stage is controlled by applying a second RF signal at a different frequency and the substrate is etched.

Such inductively coupled plasma dry etch tools allow control of selectivity between the substrate and a photoresist mask, permitting adjustment of lens properties and degree of asphericity. Lenses produced by the foregoing method can have a wide range of design parameters over a wide range of numerical apertures, including aspheric design over a broad range of conic values. Microlenses can be formed in InP, GaP, quartz and silicon, for example, although silicon is presently preferred.

As depicted in FIGS. 1A and 1B, microlens 116 may have a rectangular shape with a light transmitting portion having a curved section 118 of the lens at one end of microlens 116 and a mounting surface 119 at the opposing end of microlens 116. In the depicted embodiment the microlens has a curved section 118 on only one surface thereof, with an opposing flat surface 121. Curved section 118 is an aspheric curve having an optical axis that is aligned with the emitting center of the light emitter. In various embodiments, the light transmitting portion of microlens also has an antireflective coating applied on each of curved section 118 and opposing flat surface 121. Thus, mounting surface 119 of microlens 116 is attached to lens holder 110 while curved section 118 of microlens 116 is aligned with laser diode 102 and has an antireflective coating thereon. Attachment of microlens 116 to lens holder 110 can be enhanced by attaching a metal coating to mounting surface 119 of microlens 116. The metal coating which can then be more effectively soldered or otherwise affixed to lens holder 110. As previously mentioned, according to one embodiment of the invention microlens 116 collimates the light signal received from laser diode 102. One or more optical isolators, such as a micro isolator, may receive the light signal prior to its introduction into the optical fiber.

The z-axis alignment is individualized for each microlens 116 by measuring the radius of curvature of each microlens curved section 118 and calculating the corresponding focal length, or z distance. Preferably, each microlens is measured and a map of each lens's focal lengths is provided prior to the assembly of the optical subassembly. Selecting the proper z-axis alignment give a desired light collimation.

By way of example only, the curved section of a microlens is formed of silicon and has a diameter of about 500 microns, a thickness of about 250 microns, a radius of curvature of about 710 microns plus or minus about 35 microns, a conic constant of about −2 to −4, plus or minus about 0.5, and a clear aperture of about 450 microns. The lenses may be manufactured at a lens array pitch of about 1000 microns along rows and about 600 to about 1,000 microns along columns. The metal coating may formed of, for example, a 50 nm titanium layer, a 100 nm platinum layer, or a AuSn 1800 alloy layer in a 70:30 or 80:20 ratio. The metal coating preferably has a surface area of about 500 microns by about 400 microns. The lens antireflective coating may include, for example, a single layer nitride (transmission>97%) or a high temperature tolerant multi-layer coating (transmission>99%).

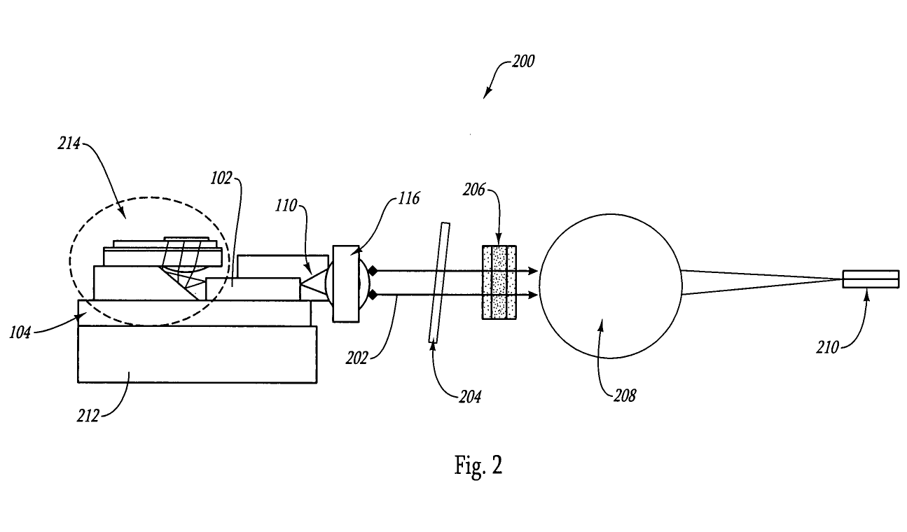

Referring now to FIG. 2, additional optional features of an optical subassembly, depicted generally at 200, are therein depicted. In the depicted embodiment, after collimated light 202 exit microlens 116, it passes through can window 204. Can window 204 is a feature of a hermetically sealed transistor outline can (not depicted), which protects various optical and electronic devices, including laser diode 102 and microlens 116, from the environment. In the depicted embodiment can window 204 is transparent and has no effect upon the collimated light 202.

Next, collimated light 202 passes through optical isolator 206. Generally, an optical isolator is a device that uses a short optical transmission path to accomplish isolation between elements of the optical device. In part, an optical isolator is used in embodiments of the present invention to counter the effects of back reflections, which would otherwise negatively impact laser diode 102. Back reflections are reflections of the laser beam, which are generally an aggregation of the reflections caused by the individual elements within the TOSA and the fiber end surface where the optical signal is launched into, that are reflected back into the laser cavity. Back reflections disturb the standing-wave oscillation in the laser cavity, increasing the effective noise floor of the laser. A strong back reflection causes certain lasers to become wildly unstable and completely unusable in some applications. Back reflections can also generate nonlinearities in the laser response which are often described as kinks. Most analog applications and some digital applications cannot tolerate these degradations.

Most often the determining factor in the magnitude of back reflections is how well the laser output is imaged onto the fiber surface, and how tightly the fiber is coupled to a laser diode. Since the fiber inserted in the TOSA is not AR coated, the reflection from the surface of the fiber constitutes a strongly coupled light back into the laser, unless the fiber is a special fiber that is not polished flat. Other optical components, such as isolators and windows, in the TOSA also contribute to reflections back towards the laser if their surfaces are not AR coated. Some lasers such lasers are not particularly susceptible to feedback, but other DFB lasers and EMLs are particularly are very sensitive to laser feedback.

Returning to FIG. 2, collimated light 202 passing through optical isolator 206 next reaches ball lens 208. Ball lenses are small, spherical lenses that focus the light received from a laser into an optical fiber 210. Currently, ball lenses must be carefully aligned at the proper focal length from the optical fiber during the manufacture of the TOSA. Advantageously, however, it is not critical how far the ball lens is positioned from the laser, microlens, or optical isolator because it receives collimated light from the microlens. This flexibility allows for an adjustable TOSA length where other components such as an isolator to be inserted in the optical path, and high alignment and assembly tolerance between the micro module and the external ball lens and fiber, greatly simplifies the manufacturing process. As mentioned earlier, ball lens 208 is optional in that microlens 116 may be configured to sufficiently couple emitted light into optical fiber 210.

One challenge of optimizing optical data transmission technology is the need to have precise control over the transmission or carrier wavelengths. Such control over the carrier wavelengths is necessary in order to provide stable communication. Problems in wavelength division multiplexing (WDM) systems, for example, occur when one or more of various multiple wavelength signals in an optical fiber begin to drift and thereby interfere with other carrier wavelengths. The need to monitor the carrier wavelengths becomes more important as the channel spacing becomes closer.

Wavelength drift can occur for a variety of different reasons, for example when optical elements within a WDM system experience a temperature variation. This is particularly true with lasers, whose transmission wavelength is affected by temperature. Accordingly, embodiments of the invention may mount silicon submount 104 on a thermoelectric cooler (TEC) 212 that is designed to keep the laser at a fairly constant temperature. The wavelength generated by the laser can be controlled by adjusting the drive current of TEC 212.

The age of a particular laser also has an impact on wavelength drift. As a laser ages, the output wavelength changes. Regardless of why the wavelength of a laser changes, however, it is necessary to ensure that the wavelength remains relatively constant. To achieve this goal, embodiments of the invention implement a feedback loop that is used to correct the wavelength being generated by the laser. In order to monitor the laser, a small portion of the laser output is siphoned off and sent to an optical element that can identify the wavelength of the laser light. One such optical element is wavelength locker 214, which received the laser output directly from a back facet of the laser rather than from a siphoned source. The output of the wavelength locker can be used to control the TEC, which controls the temperature of the laser and, ultimately, the wavelength of light emitted by the laser.

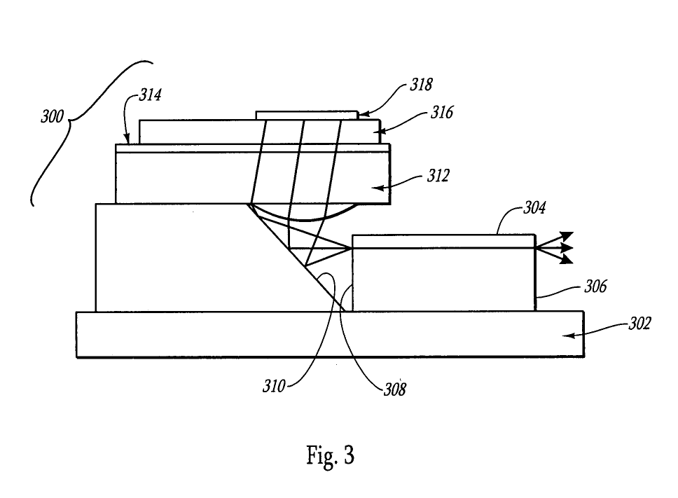

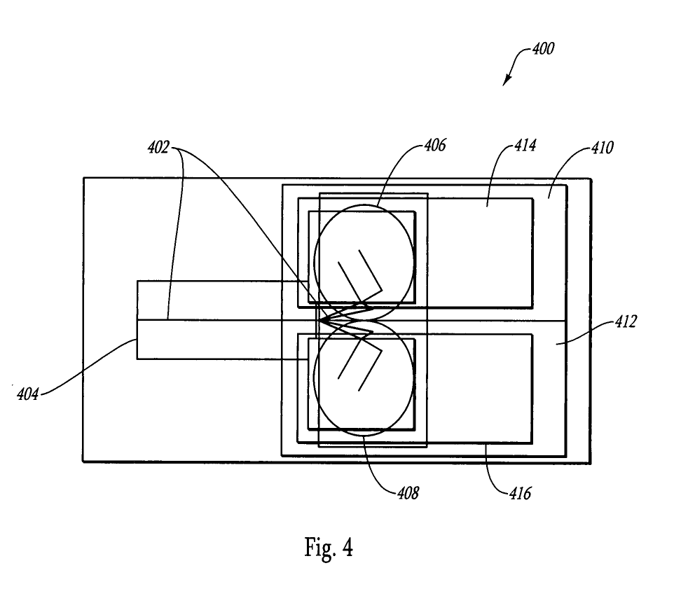

Referring now to FIG. 3, depicted is a block diagram side view of a wavelength locker 300 according to the invention. As previously mentioned, the temperature of the laser can only be adjusted appropriately after determining the transmission wavelength of the laser. Functionally, this is achieved by using wavelength locker 300 to determine the wavelength of the emitted light and adjusting the temperature of the laser as needed. Wavelength locker 300 also monitors the power of a laser.

Accordingly, adjacent wavelength locker 300 on submount 302 is a laser diode 304. The laser diode 304 may be any suitable light source including, but not limited to, an EML, a DBF laser, a FP laser, and the like. The laser diode 304 includes a front facet 306 and a back facet 308. The laser light exiting the front facet 306 is launched into a microlens as disclosed herein and on to, for instance, an optical fiber. The wavelength locker 300 utilizes the laser light exiting the back facet 308 of the laser diode 304, or received from a separate light siphon, to monitor the wavelength of the laser and/or the power of the laser.

The laser diode 304 is mounted on a thermoelectric cooler (TEC). Depending on the actual wavelength emitted by the laser diode 304, a controller will cause the TEC to alter the temperature of the laser diode 304, thereby altering the transmission wavelength of the laser diode 304. The controller makes a decision based on the wavelength detected by the wavelength locker 300.

In this example, the wavelength locker 300 includes a prism 310 (or other mirror or reflective element), one or more collimating lenses 312, a filter 314, a detector substrate 316 and one or more detectors 318. The laser light that exits the back facet 308 of the laser diode 304 is reflected by the prism 310 towards the lens 312. The lens 312 collimates the laser light and enables the light to be focused at a specific angle on the filter 314. In addition, using the lens 312 to direct or collimate the laser light can reduce or eliminate the averaging effect of having the laser light directed at the filter from multiple incident angles. The lens 312 can be adjusted in position to improve the response of the wavelength locker 300. Lens 312 may be a silicon microlens similar in construction to microlens 116 discussed in conjunction with FIGS. 1A and 1B.

The lens 312, as previously indicated, reduces the number of incident angles of light on the filter 314 such that the filter 314 is not compromised. The detector 318 may be a photodiode that can convert the laser light into a measurable electrical signal.

Referring now to FIG. 4, a top view of wavelength locker 400 is presented to illustrate further features of the functioning of the herein disclosed wavelength lockers. Accordingly, as a light signal 402 exits laser diode 404, the light signal 402 experiences its characteristic spread or emission pattern. The light signal 402 in its emission pattern reflects off a prism (not depicted) and reflects upward toward first and second microlenses 406, 408 (see lens 312 in FIG. 3). First and second microlenses collimate the light impingent thereupon so that it contacts complementary filters 410, 412 at a uniform angle (in some embodiments one filter can be omitted). Light signal 402 thus is divided into separate beams that pass through microlenses 406, 408 and filters 410, 412 and contacts power monitor and wavelength locker sensors 414 and 416. Depending on the selection of filters and steadiness of the optical power, the wavelength and/or optical power of the light signal 402 can be obtained from one of sensors 414 and 416 or by adding or subtracting the output from the sensors 414 and 416.

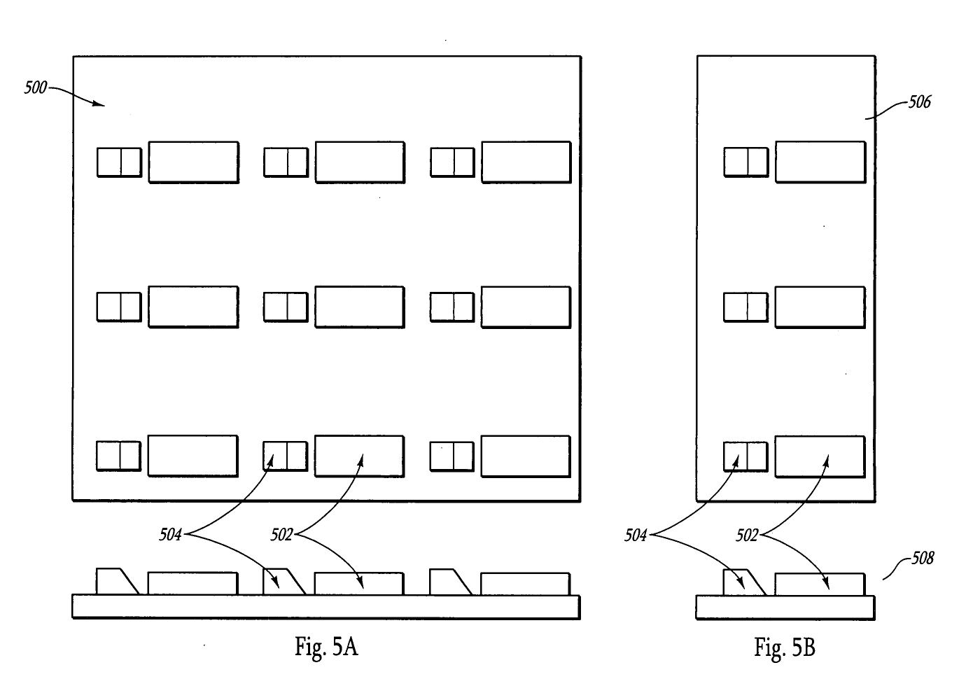

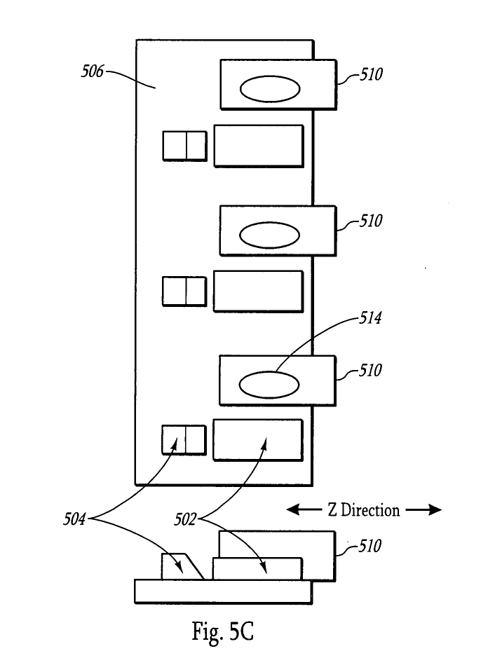

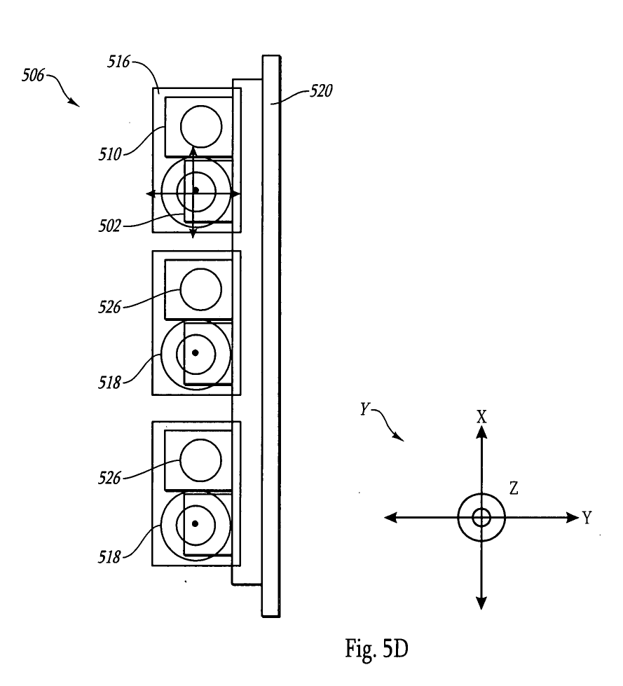

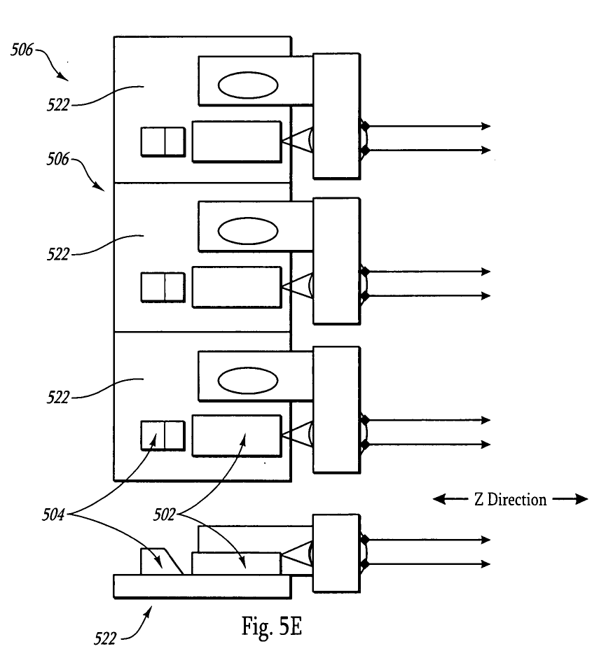

Reference is now made collectively to FIGS. 5A to 5E, which illustrate one method of manufacturing optical micro-modules according to embodiments of the invention. Silicon submount 500 as previously described is first prepared and laser diodes 502 and back monitors 504 are assembled thereon in wafer format, preferably in a grid format. The laser diodes 502 and back monitors 504 are each burned in and tested at the wafer scale.

Next, as depicted in FIG. 5B, silicon submount 500 is cut into micro-module rows 506 with micro-modules 508 (laser diode 502 and back monitor 504 on a substrate) arranged perpendicularly to the micro-module rows 506. Lens holders 510 are next aligned in the z-axis direction and mounted onto micro-module row 506 as illustrated in FIG. 5C. Each lens holder 510 is preferably soldered into place as indicated by numeral 514. By aligning each lens holder 510 in the z-axis the focal length alignment for subsequently added lenses can be avoided. The z-axis placement is dependent on the microlens that will be attached.

Referring now to FIG. 5D, each micro-module row 506 is then placed on a holding assembly 520 in preparation for receiving the lenses. The micro-module row 506 is then turned 90 degrees, for illustrative purposes, and each microlens 516 is positioned on a corresponding lens holder 510. As illustrated in FIG. 5D, bulls eye patches reference to the center of the microlenses 518 are positioned on the side of the microlens holder, directly above the axis of the laser diode 502. Of course, the alignment can be performed with or without a bulls eye patch or other similar indicators. Each microlens 516 is aligned in the x and y axis, preferably with the assistance of a camera or other visual or automatic control device, and soldered into place, as indicated by solder 526. Finally as indicated in FIG. 5E, micro-module rows 506 are flipped back horizontally and scribed at cut line 524 to break into individual micro-modules 522.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An optical micro-module comprising:
a light emitter mounted upon a substrate;
a lens holder mounted upon the substrate adjacent the light emitter, the lens holder having a mounting surface; and
a lens having a mounting surface and a curved section, the curved section having an optical axis, wherein the lens mounting surface is attached to the lens holder mounting surface and the optical axis is aligned with the light emitter.

2. An optical micro-module as defined in claim 1, wherein the lens curved section comprises a collimating microlens having an aspheric surface.

3. An optical micro-module as defined in claim 2, further comprising a ball lens to receive light from the microlens and focus the light onto an optical fiber.

4. An optical micro-module as defined in claim 1, further comprising a back monitor adjacent the light emitter for monitoring the wavelength and/or power of the light emitted by the light emitter.

5. An optical micro-module as defined in claim 1, further comprising a wavelength locker positioned adjacent a back facet of the light emitter for monitoring the wavelength and/or power of the light emitted by the light emitter.

6. An optical micro-module as defined in claim 5, wherein the wavelength locker comprises:
a reflective surface that receives light from a back facet of the light emitter and redirects the light;
a first lens that receives a first portion of the redirected laser light reflected by the reflective surface, wherein the first lens collimates the laser light;
a second lens that receives a second portion of the redirected laser light reflected by the reflective surface, wherein the second lens collimates the laser light;
a filter layer that receives the collimated light from at least one of the first lens and the second lens; and
a detector selected from the group consisting of a power sensor and a wavelength sensor, wherein the detector receives light through the filter to detect a signal and wherein at least one of the light power or light wavelength is determined from the signal.

7. An optical micro-module as defined in claim 6, further comprising a thermoelectric cooler in thermal communication with the light emitter.

8. An optical micro-module as defined in claim 1, wherein the lens mounting surface has a metal coating thereupon and the metal coating is soldered to the lens holder, thereby affixing the lens to the lens holder.

9. An optical micro-module as defined in claim 1, wherein the light emitter comprises a laser diode.

10. An optical micro-module as defined in claim 1, wherein the light emitter comprises an electroabsorptive modulated laser.

11. An optical micro-module as defined in claim 1, wherein the lens holder is aligned so that, when the lens is attached to the mounting surface of the lens holder, the lens is positioned at the desired focal length from the light emitter.

12. An optical micro-module as defined in claim 1, further comprising an optical isolator to prevent backreflections from interfering with the operation of the light emitter.

13. An optical micro-module comprising:
a substrate having a front edge;
a laser diode mounted upon the substrate;
a lens holder mounted upon the substrate adjacent the light emitter, the lens holder having a mounting surface;
a microlens for collimating or focusing light received from the laser diode, the microlens comprising a mounting surface and a curved section, wherein the microlens mounting surface is attached to the lens holder mounting surface and wherein the lens holder is aligned so that, when the microlens mounting surface is attached to the lens holder mounting surface the microlens curved section has a lens optical axis positioned at the desired focal length from the laser diode; and
a back monitor affixed to the submount and configured to receive a potion of the light emitted by the laser diode.

14. An optical micro-module as defined in claim 6, further comprising a thermoelectric cooler in thermal communication with the laser diode.

15. An optical micro-module as defined in claim 13, wherein the back monitor comprises:
a reflective surface that receives light from a back facet of the laser diode and redirects the light;
a first lens that receives a first portion of the redirected laser light reflected by the reflective surface, wherein the first lens collimates the laser light;
a second lens that receives a second portion of the redirected laser light reflected by the reflective surface, wherein the second lens collimates the laser light;
a filter later that receives the collimated light from at least one of the first lens and the second lens; and
a detector selected from the group consisting of a power sensor and a wavelength sensor, wherein the detector receives light through the filter to detect a signal and wherein at least one of the light power or light wavelength is determined from the signal.

16. An optical micro-module as defined in claim 13, further comprising an optical isolator to prevent backreflections from interfering with the operation of the laser diode.

17. A method of assembling an optical micro-module, comprising:
affixing a plurality of light emitters to a submount in a grid pattern;
separating the submount into micro-module rows with the light emitters arranged in a linear row on each micro-module row;
mounting at plurality of lens holders on the submount so that at least one of the light emitters has an adjacent lens holder, the lens holders being selectively aligned relative to the light emitter before being affixed to the submount;
placing one of the micro-module rows on a vertical holding assembly in preparation for receiving at least one microlens;
attaching a microlens to a corresponding lens holder, wherein: each microlens comprises a mounting surface and a curved section; the microlens curved section is aligned at a desired focal length from the light emitter by the position of the lens holder; and each microlens curved section has a lens optical axis that is centered with the light emitter before the microlens is attached to the lens holder; and
separating the micro-module rows individual micro-modules.

18. A method of assembling an optical micro-module as defined in claim 17, further comprising either testing the light emitter at the wafer scale before the submount is separated into rows or testing the light emitter before the submount rows are separated into individual micro modules.

19. A method of assembling an optical micro-module as defined in claim 17, further comprising the step, prior to the step of separating the submount into micro-module rows, of affixing at least one back monitor adjacent a back facet of at least one of the light emitters.

20. A method of assembling an optical micro-module as defined in claim 17, wherein the lens optical axis is centered with the light emitter with the assistance of a visual indicator that is placed on the surface of the microlens opposite the surface of the microlens that is to receive emitted light from the light emitter.

21. A method of assembling an optical micro-module as defined in claim 17, further comprising the step of affixing a wavelength locker to the submount.
